(19) United States
(12) Patent Application Publication
(10) Pub. No.: US 2026/0365421 A1
(43) Pub. Date: Nov. 19, 2026

(54) Waste Disposal Bag for a Cassette Toilet System

(71) Applicant: Stephen Charles Warstler, Zionsville, IN (US)

(72) Inventor: Stephen Charles Warstler, Zionsville, IN (US)

(21) Appl. No.: 19/315,162

(22) Filed: Aug. 29, 2025

Related U.S. Application Data
(63) Continuation-in-part of application No. 30/019,510, filed on Aug. 22, 2025.
(60) Provisional application No. 63/806,407, filed on May 15, 2025.

(51) Int. Cl. B65F 1/00

(52) U.S. Cl. CPC B65F 1/0026; B65F 1/0013; B65F 2250/105

(57) ABSTRACT

A waste disposal bag for cassette toilets is specifically designed to enable clean, odor-controlled, and environmentally responsible disposal of waste from cassette toilets. To accomplish this, the waste disposal bag comprises a uniquely shaped bag body that is strong, has high tensile strength and is biodegradable. The bag has an open neck that fits perfectly around the disposal-spout of a cassette toilet. After transferring waste from the cassette toilet, the neck with the open end may be tied with a fastener while the neck of the bag is affixed around the cassette toilet disposal-spout. Further, a gelling agent is provided inside the bag that gels the contents and renders the waste inert. Furthermore, an additional extension around the bottom end of the bag acts as an optional handle, which helps with carrying the bag for easy disposal.

The current application claims a priority to the U.S. provisional patent application Ser. No. 63/806,407 filed on May 15, 2025.

The current application is also a continuation-in-part (CIP) application of the U.S. design application Ser. No. 30/019,510 filed on Jan. 1, 2014.

### FIELD OF THE INVENTION

The present invention generally relates to waste disposal systems. More specifically, the present invention is an environmentally friendly, single-use waste disposal bag for use with cassette toilet systems. The invention addresses the need for hygienic, odor-controlled, and eco-conscious methods for disposing of human waste collected in cassette toilets.

### BACKGROUND OF THE INVENTION

Cassette toilets are commonly used in recreational vehicles (RVs), boats, and off-grid or remote environments. Traditional disposal methods for these toilets often involve direct emptying into dedicated waste stations, which can be messy, unsanitary, and difficult to access in certain locations. Current solutions such as WAG (waste alleviating gel) bags are designed for single defecation events and are not compatible with cassette toilets.

There exists a need for an innovative, practical solution for disposing of human waste from cassette toilets that minimizes environmental impact, prevents spills and odor, and is convenient for users regardless of their location. Existing technologies do not provide a solution that allows a user to hygienically and efficiently empty a cassette toilet using a disposable containment system that complies with environmental regulations.

Therefore, an objective of the present invention is to provide users with a waste disposal bag for cassette toilets, specifically designed to enable clean, odor-controlled, and environmentally responsible disposal of waste from cassette toilets.

### SUMMARY OF THE INVENTION

The present invention is a waste disposal bag for cassette toilets specifically designed to enable clean, odor-controlled, and environmentally responsible disposal of waste from cassette toilets. To accomplish this, the present invention comprises a uniquely shaped bag that is strong and has high tensile strength. Further, the bag has an open neck that fits perfectly around the disposal-spout of a cassette toilet. After transferring waste from the cassette toilet, the neck with the open end may be tied with a fastener while the neck is affixed around the cassette toilet disposal-spout. Further, a gelling agent is provided inside the bag that gels the contents and renders the waste inert. Furthermore, an additional extension around the bottom end of the bag acts as an optional handle, which helps with carrying the bag for easy disposal.

### BRIEF DESCRIPTION OF THE DRAWINGS

FIG. 1 is a schematic diagram of the present invention.

FIG. 2 is a top-front-left perspective view of the present invention.

FIG. 3 is a bottom-rear-right perspective view of the present invention.

FIG. 4 is a left side elevational view of the present invention.

FIG. 5 is a rear elevational view of the present invention.

FIG. 6 is a top plan view of the present invention.

FIG. 7 is a bottom plan view of the present invention.

FIG. 8 is a front elevational view of the present invention with a fastener on the side.

FIG. 9 is a front elevational view of the present invention, wherein the fastener is tied around the proximal extension of the waste disposal bag.

FIG. 10 is a perspective view, wherein the waste disposal bag is placed within a support bucket, and wherein the proximal extension is positioned outside of the open end of the bucket.

FIG. 11 is a front elevational view, wherein a tied-up waste disposal bag is placed within the support bucket.

### DETAILED DESCRIPTION OF THE INVENTION

All illustrations of the drawings are for the purpose of describing selected versions of the present invention and are not intended to limit the scope of the present invention.

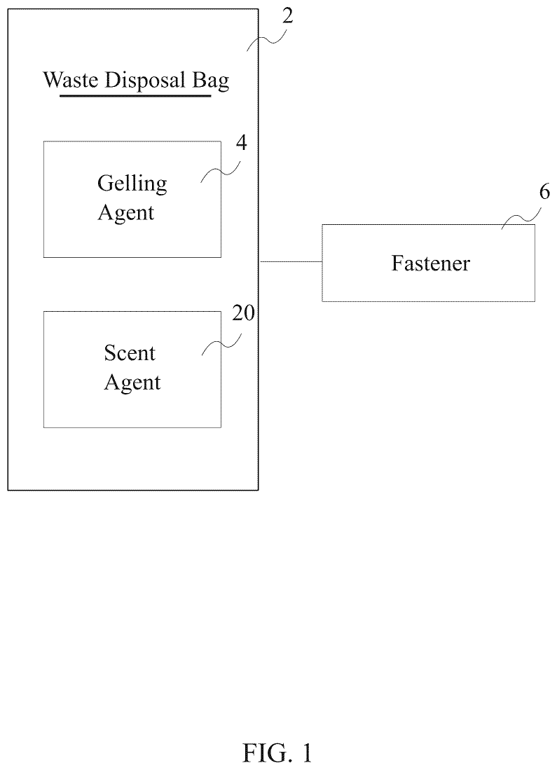

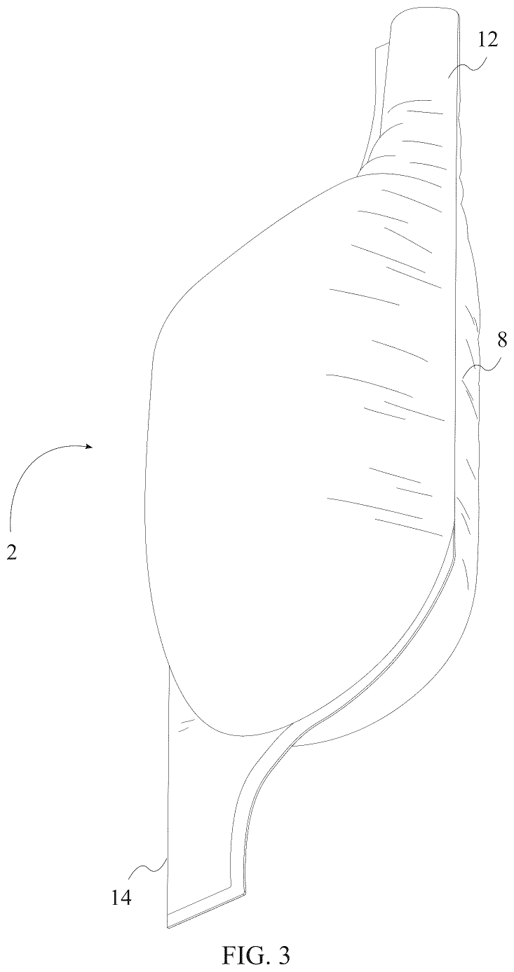

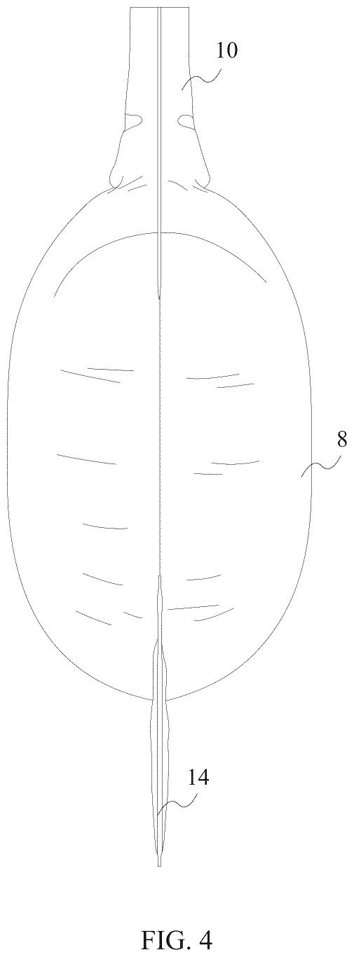

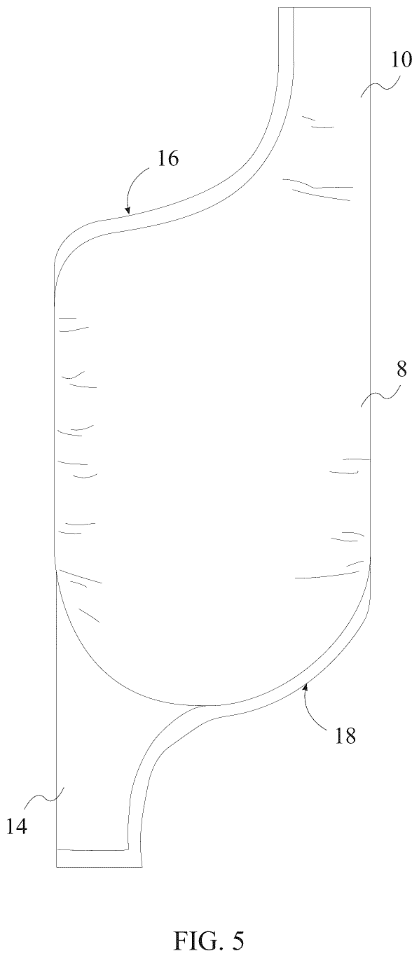

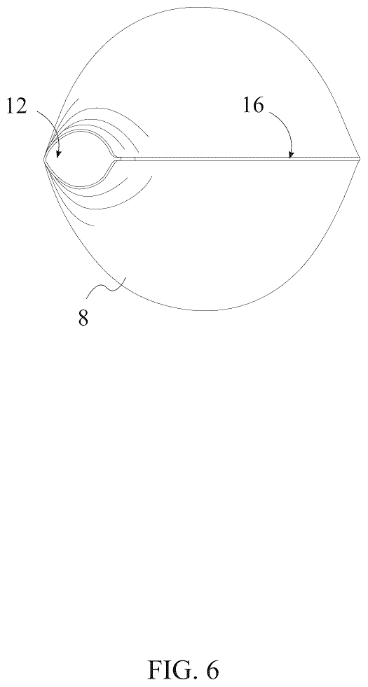

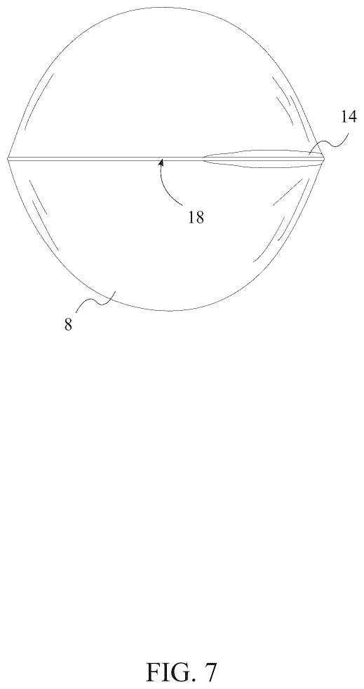

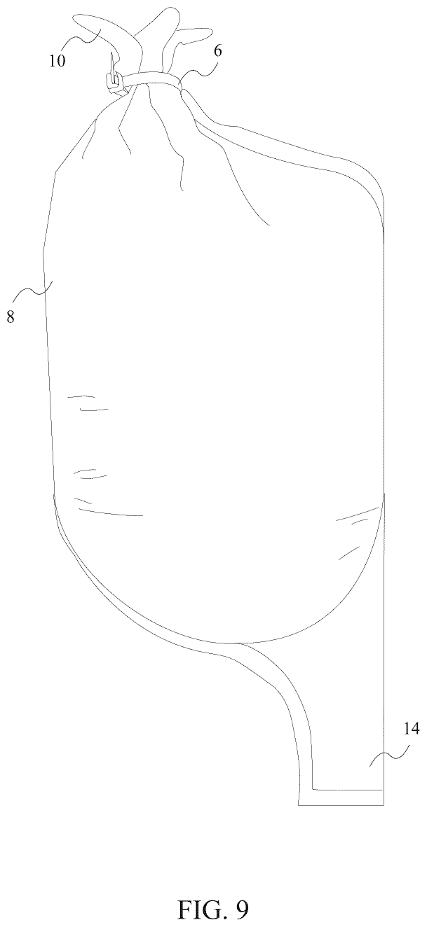

In reference to FIG. 1 through FIG. 11, the present invention is a cassette toilet human waste disposal bag specifically designed to enable clean, odor-controlled, and environmentally responsible disposal of waste from cassette toilet.

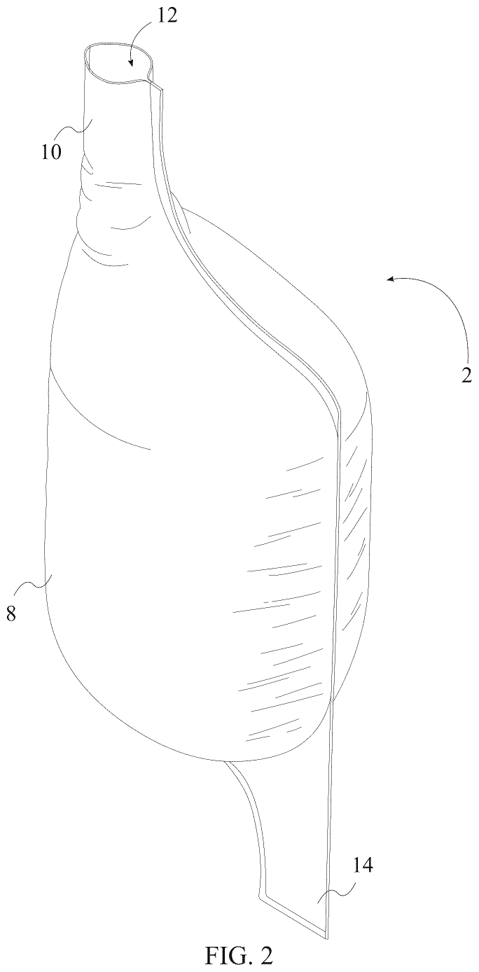

According to a preferred embodiment, the present invention comprises a waste disposal bag 2, a quantity of gelling agent 4, and a fastener 6. Preferably, the waste disposal bag 2 is a uniquely shaped eco-friendly bag made of recycled plastic or biodegradable film holding approximately 6 gallons. The waste disposal bag 2 may be produced in a variety of colors including black, white, or green. Further, the bag is made from tubular film and hence there are no seams on the side of the bag. This increases the tensile strength of the bag. As seen in FIG. 2 through FIG. 11, the waste disposal bag 2 comprises a bag body 8, a proximal extension 10, a bag-entrance hole 12, and a distal extension 14. Preferably, the bag body 8 is the main central portion of the waste disposal bag 2, that is approximately 20″ wide and 40″ long. In the preferred embodiment, the bag material tested 86.4 % degradation in 856 days. Thus, the waste disposal bag 2 is made of a biodegradable material. The waste disposal bag 2 may also be produced using recycled plastic, reducing the environmental impact. However, any other measurements and materials may be used for the waste disposal bag 2, as long as the intents of the present invention are not altered. In the preferred embodiment, the bag body 8 comprises a first bag end 16 and a second bag end 18, wherein the first bag end 16 is positioned opposite the second bag end 18 about the bag body 8. Preferably, the first bag end 16 constitutes a top end of the bag body 8 and the second bag end 18 constitutes a bottom end of the bag body 8. Further, the proximal extension 10 is a neck segment that is intended to attach to the disposal-spout of the cassette toilet. To that end, the proximal extension 10 is positioned adjacent to the first bag end 16. The distal extension 14 is an extension hanging from the bottom end of the bag body 8. This is so that the distal extension 14 may be used as a handle while carrying the waste disposal bag 2 for disposal. In other words, the distal extension 14 is configured to be an additional weight distributing handle while carrying the waste disposal bag 2 filled with a maximum amount of waste. Preferably, the distal extension 14 is positioned adjacent to the second bag end 18. As seen in FIG. 2 through FIG. 5, the proximal extension 10 is laterally offset from the distal extension 14 along a width of the bag body 8. In other words, the proximal extension 10 is positioned opposite to the distal extension 14 about the bag body 8.

In order to transfer waste from inside the cassette toilet into the waste disposal bag 2, the bag-entrance hole 12 traverses through and along the proximal extension 10. In other words, the bag-entrance hole 12 is configured to affix around a disposal-spout of a cassette toilet. The bag-entrance hole 12 further traverses into the bag body 8. Preferably, the bag-entrance hole 12 is 6.5″ wide and the proximal extension 10 is 10″ tall.

A feature of the present invention is its ability to turn liquids and solids of human waste into a gel, rendering the waste inert. This ensures that the waste doesn't flow, thereby enabling environmentally friendly disposal. To accomplish this, the quantity of gelling agent 4, or a superabsorbent polymer (SAP) such as sodium polyacrylate (an antibacterial gelling agent) is provided inside the bag body 8. In other words, the quantity of gelling agent 4 is retained within the bag body 8. When interacting with the waste, the gelling agent gels the contents and renders the waste inert, meaning it will not flow. This helps with easy and cleaner disposal. Thus, the quantity of gelling agent 4 is configured to convert solid and liquid waste into a gel form.

According to the preferred embodiment, a feature of the present invention is its ability to securely close bag spout to prevent spillage by securing with the fastener 6. In other words, the fastener 6 is operatively integrated around the proximal extension 10, wherein the fastener 6 is used to selectively pinch the proximal extension 10 and to selectively close off the bag body 8. Preferably, the fastener 6 is a zip tie. However, any other fastener 6, such as an elastic band, a strand, a string, etc. may be used, as long as the intent of the present invention is not altered.

In order to provide a non-smelly environment while dealing with the waste disposal bag 2 and disposal of the bag after filling and sealing, the present invention may further comprise a quantity of scent agent 20, wherein the quantity of scent agent 20 is retained within the bag body 8. The quantity of scent agent 20 may be made of any chemical or natural composition having a pleasant smell or any odor cancelling fragrance, as long as the objectives of the present invention are fulfilled.

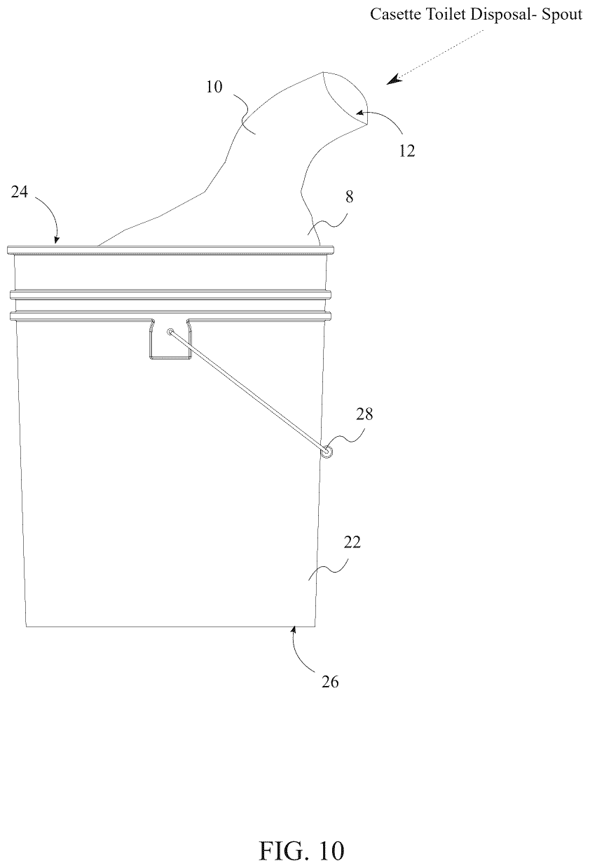

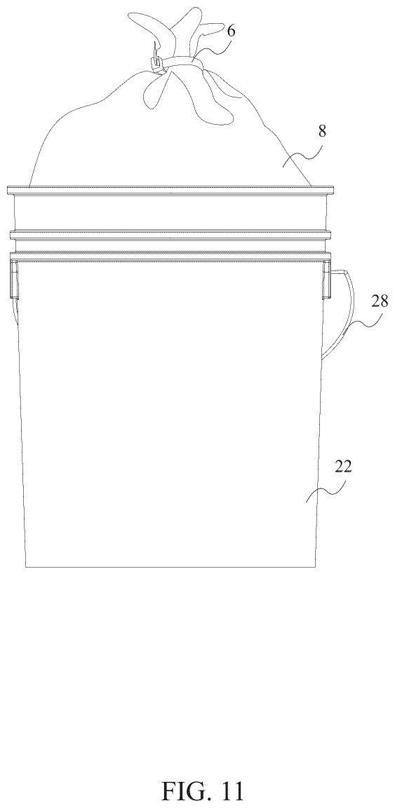

Continuing with the preferred embodiment, the present invention may further comprise a support bucket 22, that can help with holding the waste disposal bag 2, while transferring the contents of the cassette toilet into the waste disposal bag 2. Preferably, the support bucket is big enough to hold the waste disposal bag 2 and is made of a solid material such as hard plastic or metal. However, the support bucket 22 may have any other dimensions and/or materials, as long as the intents of the present invention are not hindered. As seen in FIG. 10, the support bucket 22 may comprise an open support bucket end 24 and a closed support bucket end 26. Preferably, the open support bucket end 24 is a top end of the support bucket 22, and the closed support bucket end 26 constitutes a bottom end of the support bucket 22. In other words, the open support bucket end 24 is positioned opposite the closed support bucket end 26 about the support bucket 22. As seen in FIG. 10 and FIG. 11, the waste disposal bag 2 is removably positioned through the open support bucket end 24 and into the support bucket 22. Further, the proximal extension 10 and the first bag end 16 is positioned outside of the support bucket 22, adjacent to the open support bucket end 24. Moreover, the support bucket 22 may further comprise a support bucket handle 28. The support bucket handle 28 is intended to help with carrying or transporting the bucket from one point to another. To that end, the support bucket handle 28 is laterally mounted onto the support bucket 22, adjacent to the open support bucket end 24. Thus, according to the present invention, the support bucket 22 is configured to receive and support the waste disposal bag 2 by rigidly encasing the waste disposal bag 2 during transferring of waste from a cassette toilet into the waste disposal bag 2.

In an alternate embodiment of the present invention, the waste disposal bag 2 may further comprise a bag handle, wherein the bag handle is mounted onto the first bag end 16. The bag handle helps users carry the waste disposal bag 2 from the top end. Preferably, the bag handle is positioned offset from the proximal extension 10.

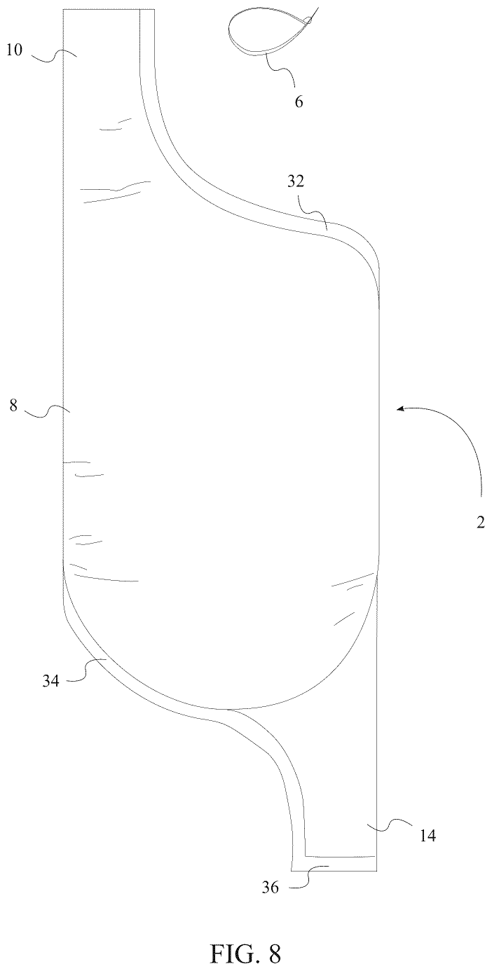

In order to provide additional structural integrity, and strength to the waste disposal bag 2, the top and bottom end of the bag are additionally strengthened. To that end, the present invention may further comprise a hole reinforcing seam 32. The hole reinforcing seam 32 is an additional stitching or welding along the bag body 8, that can provide additional strength to the top end of the bag body 8. As seen in FIG. 8, the hole reinforcing seam 32 is integrated into the waste disposal bag 2 along the first bag end 16, along the proximal extension 10, and up to the bag-entrance hole 12. Similarly, the present invention may further comprise a bag reinforcing seam 34 and an extension reinforcing seam. The bag reinforcing seam 34 and extension reinforcing seam 36 are additional stitching or welding along the bag body 8, that can provide additional strength to the lower end of the bag body 8. Accordingly, the bag reinforcing seam 34 is integrated into the waste disposal bag 2 along the second bag end 18, and the extension reinforcing seam 36 is integrated into the waste disposal bag 2 from the second bag end 18 and around the distal extension 14.

Thus, the present invention allows a user to empty the human waste from a cassette toilet in an eco-friendly manner anywhere and at any time without any spills and odor.

A preferred method or procedure for emptying the cassette toilet into the disclosed cassette toilet waste disposal bag follows:
With the support bucket on a solid surface, place the waste disposal bag inside the support bucket.
Attach the neck (proximal extension) of bag onto cassette discharge-spout and secure with a reusable zip tie.
Place cassette on solid surface and push air release button allowing waste to flow into bag; elevate rear of cassette to complete emptying of waste into the bag. p1 Optionally add ½gallon of clean water to rinse cassette and discharge if desired.
Loosen reusable zip tie and remove neck of bag from cassette toilet.
Gather the neck of the bag while releasing excess air in bag, and secure with the same zip tie.

Although the invention has been explained in relation to its preferred embodiment, it is to be understood that many other possible modifications and variations can be made without departing from the spirit and scope of the invention as hereinafter claimed.

What is claimed is:

1. A cassette toilet waste disposal system comprising:
a waste disposal bag;
a quantity of gelling agent;
a fastener;
the waste disposal bag comprising a bag body, a proximal extension, a bag-entrance hole, and a distal extension;
the bag body comprising a first bag end and a second bag end;
the first bag end being positioned opposite the second bag end about the bag body;
the proximal extension being positioned adjacent to the first bag end;
the distal extension being positioned adjacent to the second bag end;
the bag-entrance hole traversing through and along the proximal extension;
the bag-entrance hole further traversing into the bag body;
the quantity of gelling agent being retained within the bag body; and
the fastener being operatively integrated around the proximal extension, wherein the fastener is used to selectively pinch the proximal extension and to selectively close off the bag body.

2. The cassette toilet waste disposal system of claim 1 comprising:
a support bucket;
the support bucket comprising an open support bucket end and a closed support bucket end;
the open support bucket end being positioned opposite the closed support bucket end about the support bucket;
the waste disposal bag being removably positioned through the open support bucket end and into the support bucket; and
the proximal extension and the first bag end being positioned outside of the support bucket, adjacent to the open support bucket end.

3. The cassette toilet waste disposal system of claim 2 comprising:
the support bucket further comprising a support bucket handle; and
the support bucket handle being laterally mounted onto the support bucket, adjacent to the open bucket end.

4. The cassette toilet waste disposal system of claim 2, wherein the support bucket is configured to receive and support the waste disposal bag by rigidly encasing the waste disposal bag during transferring of waste from a cassette toilet into the waste disposal bag.

5. The cassette toilet waste disposal system of claim 1 comprising:
the waste disposal bag further comprising a bag handle;
the bag handle being mounted onto the first bag end; and
the bag handle being positioned offset from the proximal extension.

6. The cassette toilet waste disposal system of claim 1 comprising:
a quantity of scent agent; and
the quantity of scent agent being retained within the bag body.

7. The cassette toilet waste disposal system of claim 1, wherein the bag-entrance hole is configured to affix around a disposal-spout of a cassette toilet.

8. The cassette toilet waste disposal system of claim 1, wherein the quantity of gelling agent is configured to convert solid and liquid waste into a gel form.

9. The cassette toilet waste disposal system of claim 1, wherein the waste disposal bag is made of biodegradable material.

10. The cassette toilet waste disposal system of claim 1, wherein the proximal extension is laterally offset from the distal extension along a width of the bag body.

11. The cassette toilet waste disposal system of claim 1, wherein the distal extension is configured to be an additional weight distributing handle while carrying the waste disposal bag filled with a maximum amount of waste.

12. The cassette toilet waste disposal system of claim 1, wherein the fastener is a zip tie.

13. The cassette toilet waste disposal system of claim 1 comprising:
a hole reinforcing seam; and
the hole reinforcing seam being integrated into the waste disposal bag along the first bag end, along the proximal extension, and up to the bag extension hole.

14. The cassette toilet waste disposal system of claim 1 comprising:
a bag reinforcing seam; and
the bag reinforcing seam being integrated into the waste disposal bag along the second bag end.

15. The cassette toilet waste disposal system of claim 1 comprising:
an extension reinforcing seam; and
the extension reinforcing seam being integrated into the waste disposal bag from the second bag end and around the distal extension.
